(19) United States
(12) Patent Application Publication
(10) Pub. No.: US 2010/0188076 A1
(43) Pub. Date: Jul. 29, 2010

(54) MICROELECTRONIC SENSOR DEVICE WITH MAGNETIC FIELD GENERATOR AND CARRIER

(75) Inventors: Josephus Arnoldus Henricus Maria Kahlman, Tilburg (NL); Jeroen Veen, Nijmegen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/667,396

(22) PCT Filed: Oct. 23, 2007
(86) PCT No.: PCT/IB07/54303

§ 371 Date: Dec. 31, 2009

(30) Foreign Application Priority Data
Jul. 9, 2007 (EP) 07112085.1

(51) Int. Cl. G01N 27/72

(52) U.S. Cl. 324/232

(57) ABSTRACT

The invention relates to a microelectronic sensor device for manipulating a sample in an exchangeable carrier (111), for example for optically detecting target particles (1) in a sample liquid that is provided in a sample chamber (2) of the carrier (111). The microelectronic sensor device comprises a number of n>1 magnetic field generators (141-143), e.g. electromagnetic coils, with which magnetic fields can be generated in a target region (110). A control unit (150) is provided that can determine and evaluate the mutual coupling or the self-inductance of the magnetic field generators and/or signals from magnetic field sensors attached to the carrier with respect to the presence and/or state of a carrier (111) in the target region (110). In this way, the control unit (150) can for example detect if the carrier (111) is correctly positioned in the sensor device and/or where a magnetically interactive substance (1, 120) is located.

The invention relates to a method and a microelectronic sensor device for manipulating a sample in an exchangeable carrier, wherein magnetic fields are generated in the sample. Moreover, it relates to a carrier for such a device and to the use of such a device and carrier.

The US 2005/0048599 A1 discloses a method for the investigation of microorganisms that are tagged with particles such that a (e.g. magnetic) force can be exerted on them. In one embodiment of this method, a light beam is directed through a transparent material to a surface where it is totally internally reflected. Light of this beam that leaves the transparent material as an evanescent wave is scattered by microorganisms and/or other components at the surface and then detected by a photodetector or used to illuminate the microorganisms for visual observation. A problem of this and similar setups arises from the fact that they typically use exchangeable (disposable) cartridges for supplying the samples to be treated, which are prone to an incorrect placement in the device. As a consequence, the intended manipulations, e.g. optical measurements, can be severely impaired.

Based on this situation it was an object of the present invention to provide alternative means for manipulating a sample, wherein it is desirable that a higher robustness is achieved with respect to the use of exchangeable components.

This object is achieved by a microelectronic sensor device according to claim 1, a carrier according to claim 14, a method according to claim 17, and a use according to claim 18. Preferred embodiments are disclosed in the dependent claims.

The microelectronic sensor device according to the present invention serves for manipulating a sample in an exchangeable carrier (wherein the carrier does not necessarily belong to the device). The term “manipulating” shall denote any interaction with said sample, for example measuring characteristic quantities of the sample, investigating its properties, processing it mechanically or chemically, or the like. The carrier (also called “cartridge” in the following) will usually be made from a transparent material, for example glass or polystyrene, to allow the propagation of light of a given (particularly visible, UV, and/or IR) spectrum. The microelectronic sensor device comprises the following components:
a) A number of n≧1 magnetic field generators for generating magnetic fields in a “target region”, wherein said target region is typically a (macroscopic) volume at a fixed relative position with respect to the sensor device. The magnetic fields may serve for many different purposes, for example for the magnetization of sample particles and/or the forced movement of magnetic particles in field gradients. It should be noted that there may be just one single magnetic field generator (for n=1) despite the fact that the following text always speaks of these components in plural. The magnetic field generators may particularly be realized by electromagnets, i.e. in the most general sense electrical conductors through which an electrical current can flow, thereby inducing a magnetic field around it. To increase the strength of this magnetic field, the conductor will typically be wound as a coil with a plurality of loops.
b) A control unit with an input for receiving (by wire or wirelessly) detection signals that indicate a magnetic effect caused by the magnetic field generators, wherein the control unit is adapted to evaluate the detection signals with respect to the presence and/or the state of a carrier in the target region. The control unit may be realized by dedicated (analog) electronic hardware, by digital data processing hardware with appropriate software, or by a mixture of both. As a result of its evaluation procedure, the control unit will typically provide a digital or analogue output signal indicative of the presence and/or state (e.g. filling state, alignment etc.) of the carrier in the target region.

The described microelectronic sensor device has the advantage that it exploits effects which are already present, e.g. a magnetic interaction between the magnetic field generators and a carrier, to derive information about an exchangeable carrier that is used together with the sensor device. This information may be very helpful to increase the accuracy and robustness of the microelectronic sensor device, as a correct positioning/state of the carrier is crucial for many processes.

According to a first basic approach for providing detection signals to the control unit, said control unit is coupled to the magnetic field generators and the detection signals are (at least in part) related to the mutual coupling and/or the self-inductance of the magnetic field generators. This approach has the advantage that the magnetic field generators—which are often already present for other purposes—are additionally used for sensing the presence and/or state of the carrier based on the effects said presence/state has on the mutual coupling and/or the self-inductance. It should be noted that the “mutual coupling” between two or more magnetic field generators describes the strength with which the magnetic field of one of them acts on the other(s); in electromagnets, a changing magnetic field may for example induce a voltage in conductor wires. The “mutual coupling” can in this case be identified with the proportionality factor between the change of magnetic flux, dΦ/dt, and the induced voltage U. The “self-inductance” similarly characterizes the voltage that a magnetic field generated by a current in a conductor wire induces in said wire itself.

According to a second basic approach for providing detection signals to the control unit, the detection signals are (at least in part) provided by at least one magnetic field sensor attached to the carrier. With the help of one or more of such magnetic field sensors, the magnetic fields of the magnetic field generators can be sensed, thus providing valuable information about the presence and/or state of the carrier to which the sensors are attached at a fixed relative position. In case of an incorrect positioning of the carrier, the magnetic field sensor(s) may optionally even provide information about the direction in which said position has to be changed.

The control unit may optionally be coupled to the magnetic field generators and be adapted to control them such that their magnetic fields mutually cancel at a given location in the target region. Two electromagnets on opposite sides of the target region may for example be simultaneously supplied with current pulses of opposite direction, yielding a cancellation of the magnetic fields in the middle between the electromagnets. The location where the magnetic fields cancel can readily and precisely be determined, particularly with the help of a magnetic field sensor of the kind described above. For detecting the location of a vanishing magnetic field, the magnetic field sensor only needs to be sensitive to magnetic fields, but not necessarily be precise or well calibrated.

In a preferred embodiment of the microelectronic sensor device, the target region is located between at least two magnetic field generators. In this case magnetic fields can be induced in the target region from two sides, allowing for example the selective movement of magnetic particles in opposite directions. Moreover, such a design has the advantage that the mutual coupling of the magnetic field generators is maximally affected by the conditions in the intermediate target region, i.e. it is maximally sensitive to the presence and/or state of a carrier in said region.

Depending on the particular application of the microelectronic sensor device, the carrier may have many different concrete designs. In a preferred embodiment, the carrier comprises a sample chamber in which a sample can be provided, particularly a sample containing magnetic particles. In this context, the term “magnetic particle” shall denote a particle (atom, ion, molecule, complex, nano-particle, micro-particle etc.) which is (permanently) magnetic or which is magnetizable. The presence or absence of a sample in the sample chamber, particularly of a sample with magnetic particles, will usually affect the magnetic fields that are generated by the magnetic field generators in the sample chamber and will therefore also have an effect on the coupling or self-inductance of said field generators. In other words, the presence and/or state of such a sample can be detected by observing the magnetic field in the chamber and/or the mutual coupling and/or self-inductance of the magnetic field generators.

The control unit may particularly be adapted to determine the position of a magnetically interactive substance in or at the carrier, i.e. a substance that is attached at a fixed position to the carrier or that is present in the sample chamber of the carrier. The magnetically interactive substance may for example be a magnetic marker attached to the carrier for affecting magnetic fields in a definite way, or it may be a substance (e.g. magnetic particles serving as labels) that is present in a sample to be manipulated. Determining the position of such a magnetically interactive substance allows to correct the positioning of the carrier with respect to the microelectronic sensor device, or, if the substance and the carrier have no constant relative position, to correct the position of the magnetically interactive substance with respect to the microelectronic sensor device. In the latter case, the carrier can for example be moved to a position in which the magnetically interactive substance inside it attains a required position with respect to the microelectronic sensor device, or the manipulation processes of the microelectronic sensor device (e.g. an illumination with light beams) can selectively be focused to the detected position of the magnetically interactive substance.

According to a preferred embodiment of the invention, the control unit comprises a modulator for modulating the magnetic field of at least one of the magnetic field generators. The modulation of the fields may for example comprise a simple on/off switching with a random or regular repetition pattern, or the application of some given modulation function, e.g. a sinusoidal modulation. By modulating the magnetic fields in a controlled way, voltages are induced in the magnetic field generators that provide information about their mutual coupling and/or self-inductance.

The control unit may further comprise a voltage sensor for sensing the voltage between two terminals, particularly two terminals of at least one of the magnetic field generators. As the latter voltage is related to the mutual coupling and/or self-inductance of the magnetic field generators, it provides a suitable measure of these values. This is particularly the case if the magnetic fields are known due to a controlled modulation.

In a further development of the aforementioned embodiment, the control unit may comprise an evaluation unit for evaluating the measured voltages, wherein this evaluation may particularly be accomplished in the time domain or in the frequency domain.

In another embodiment of the invention, the control unit is adapted to control components of the microelectronic sensor device in dependence on its evaluation results, i.e. in dependence on the detected presence and/or state of the carrier in the target region. Thus the control unit may function as a kind of higher-level controller that for example blocks the start of measurements as long as no carrier is (correctly) positioned in the target region. Similarly, the control unit may automatically start manipulation procedures, e.g. optical measurements, as soon as the carrier is (correctly) placed in the microelectronic sensor device and/or as soon as a target substance is detected at a desired position. This avoids faulty measurements, thus saving time, material and energy. Moreover, the accuracy and reproducibility of measurements is improved as the control is based on objective conditions and not on the subjective decision of a user.

The described microelectronic sensor device may optionally comprise a light source for emitting a light beam, called “input light beam” in the following, into the carrier such that it is totally internally reflected at a contact surface of the carrier. The light source may for example be a laser or a light emitting diode (LED), optionally provided with some optics for shaping and directing the input light beam. The contact surface must comprise an interface between two media, e.g. glass and water, at which total internal reflection (TIR) can take place if the incident light beam hits the interface at an appropriate angle (larger than the associated critical angle of TIR). Such a setup may be used to examine small volumes of a sample at the TIR-interface which are reached by exponentially decaying evanescent waves of the totally internally reflected beam. Target components—e.g. atoms, ions, (bio-)molecules, cells, viruses, or fractions of cells or viruses, tissue extract, etc.—that are present in the investigation region can then scatter the light of the evanescent waves which will accordingly be missing in the reflected light beam. In this scenario of a “frustrated total internal reflection”, the output light beam of the sensor device will consist of the reflected light of the input light beam, wherein the small amount of light missing due to scattering of evanescent waves contains the desired information about the target components in the investigation region.

To allow for the aforementioned measurements, the microelectronic sensor device preferably comprises a light detector for determining a characteristic parameter, e.g. the amount of light, of the output light beam. The detector may comprise any suitable sensor or plurality of sensors by which light of a given spectrum can be detected, for example photodiodes, photo resistors, photocells, a CCD chip, or a photo multiplier tube.

The invention further relates to a carrier for a microelectronic sensor device of the kind described above, wherein said carrier comprises a magnetically interactive marker at a fixed relative location. The marker may typically be a more or less extended body of a magnetizable material, e.g. comprising iron, which can affect magnetic fields in its surroundings. The presence of such a marker in the target region of a microelectronic sensor device of the kind described above can thus be detected based on the influence it has on magnetic fields and/or on the mutual coupling and/or self-inductance of magnetic field generators that reach into said target region.

The invention also comprises a carrier with at least one magnetic field sensor for determining the magnetic field generated by the magnetic field generators of a microelectronic sensor device of the kind defined above. Such a carrier can be used in connection with the second basic approach described above, in which the control unit is adapted to receive and evaluate detection signals from at least one magnetic field sensor.

The aforementioned magnetic field sensor may particularly comprise a coil with one or more loops, a Hall sensor, a planar Hall sensor, a flux gate sensor, a SQUID (Superconducting Quantum Interference Device), a magnetic resonance sensor, a magneto-restrictive sensor, or a magneto-resistive sensor of the kind described in the WO 2005/010543 A1 or WO 2005/010542 A2, especially a GMR (Giant Magneto Resistance), a TMR (Tunnel Magneto Resistance), or an AMR (Anisotropic Magneto Resistance).

The carrier with the magnetic field sensor may further optionally comprise electrical contact terminals via which the magnetic field sensor can be accessed by an external device, particularly by a microelectronic sensor device of the kind described above.

The invention further relates to a method for manipulating a sample in an exchangeable carrier, comprising the steps of:
a) Generating a magnetic field in a target region with a number of n≧1 magnetic field generators.
b) Evaluating a magnetic effect caused by the magnetic field generators (e.g. the generated magnetic field in the target region or the mutual coupling and/or self-inductance of the magnetic field generators) with respect to the presence and/or state of the carrier in the target region.

The method comprises in general form the steps that can be executed with a microelectronic sensor device of the kind described above. Therefore, reference is made to the preceding description for more information on the details, advantages and improvements of that method.

The invention further relates to the use of the microelectronic device and/or the carrier described above for molecular diagnostics, biological sample analysis, or chemical sample analysis, food analysis, and/or forensic analysis. Molecular diagnostics may for example be accomplished with the help of magnetic beads or fluorescent particles that are directly or indirectly attached to target molecules.

These and other aspects of the invention will be apparent from and elucidated with reference to the embodiment(s) described hereinafter. These embodiments will be described by way of example with the help of the accompanying drawings in which:

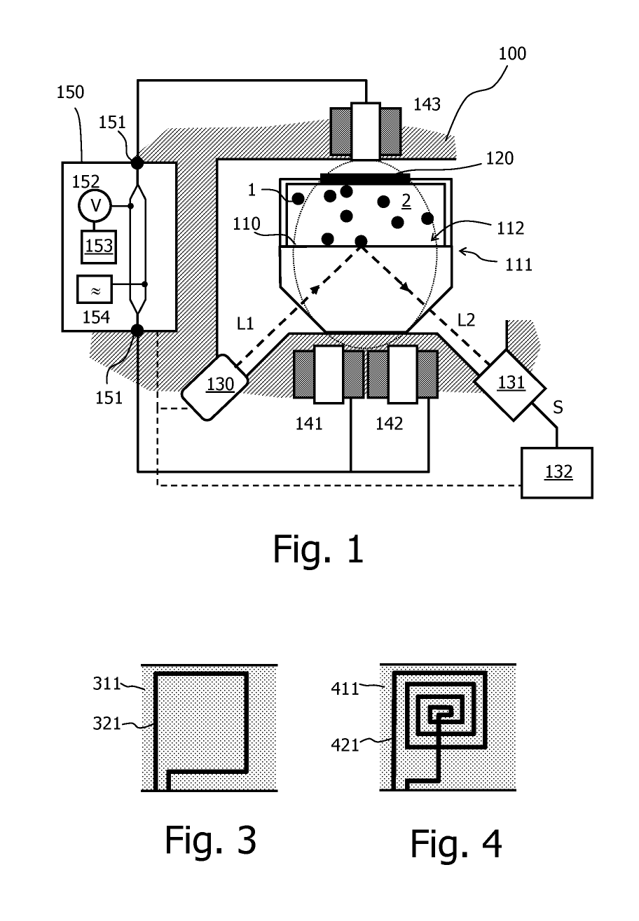

FIG. 1 schematically shows a first embodiment of a microelectronic sensor device according to the present invention in which the mutual coupling of magnetic field generators is measured;

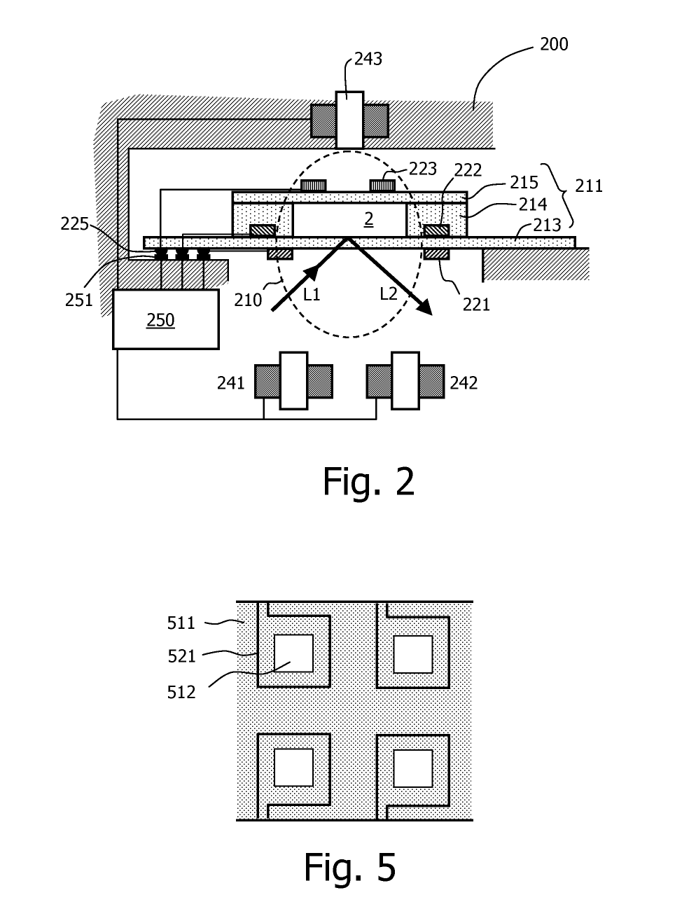

FIG. 2 schematically shows a second embodiment of a microelectronic sensor device in which magnetic field sensors are attached to a carrier;

FIGS. 3 to 5 show top views of coils serving as magnetic field sensors on a carrier.

Like reference numbers or numbers differing by integer multiples of 100 refer in the Figures to identical or similar components.

Though the present invention will in the following be described with respect to a particular setup (using magnetic particles and frustrated total internal reflection as measurement principle), it is not limited to such an approach and can favorably be used in many different applications and setups.

FIG. 1 shows a setup with a microelectronic sensor device 100 according to the present invention. A central component of this setup is the carrier 111 that may for example be made from glass or transparent plastic like polystyrene. The carrier 111 comprises a sample chamber 2 in which a sample fluid with target components to be detected (e.g. drugs, antibodies, DNA, etc.) can be provided. The sample further comprises magnetic particles, for example superparamagnetic beads, wherein these particles are usually bound as labels to the aforementioned target components. For simplicity only the combination of target components and magnetic particles is shown in the Figure and will be called “target particle 1” in the following. It should be noted that instead of magnetic particles other label particles, for example electrically charged or fluorescent particles, could be used as well.

The interface towards the sample chamber 2 is formed by a surface called “contact surface” 112. This contact surface 112 is coated with capture elements, e.g. antibodies, which can specifically bind the target particles.

The sensor device comprises magnetic field generators 141, 142, and 143, for example electromagnets with a coil and a core, for controllably generating a magnetic field at the contact surface 112 and in the sample chamber 2. With the help of this magnetic field, the target particles 1 can be manipulated, i.e. be magnetized and particularly be moved (if magnetic fields with gradients are used). Thus it is for example possible to attract target particles 1 to the contact surface 112 in order to accelerate the binding of the associated target particle to said surface, or to wash unbound target particles away from the contact surface before a measurement.

The sensor device further comprises a light source 130 that generates an input light beam L1 which is transmitted into the carrier 111 through an “entrance window”. As light source 130, a laser or an LED, particularly a commercial DVD (λ=658 nm) laser-diode can be used. A collimator lens may be used to make the input light beam L1 parallel, and a pinhole of e.g. 0.5 mm may be used to reduce the beam diameter. The input light beam L1 arrives at the contact surface 112 at an angle larger than the critical angle θ_{c} of total internal reflection (TIR) and is therefore totally internally reflected in an “output light beam” L2. The output light beam L2 leaves the carrier 111 through another surface (“exit window”) and is detected by a light detector 131. The light detector 131 determines the amount of light of the output light beam L2 (e.g. expressed by the light intensity of this light beam in the whole spectrum or a certain part of the spectrum). The measured sensor signals S are evaluated and optionally monitored over an observation period by an evaluation and recording module 132 that is coupled to the detector 131.

It is possible to use the detector 131 also for the sampling of fluorescence light emitted by fluorescent particles 1 which were stimulated by the input light beam L1, wherein this fluorescence may for example spectrally be discriminated from reflected light L2. Though the following description concentrates on the measurement of reflected light, the principles discussed here can mutatis mutandis be applied to the detection of fluorescence, too.

The described microelectronic sensor device applies optical means for the detection of target particles 1. For eliminating or at least minimizing the influence of background (e.g. of the sample fluid, such as saliva, blood, etc.), the detection technique should be surface-specific. As indicated above, this is achieved by using the principle of frustrated total internal reflection (FTIR). This principle is based on the fact that an evanescent wave penetrates (exponentially dropping in intensity) into the sample 2 when the incident light beam L1 is totally internally reflected. If this evanescent wave then interacts with another medium like the bound target particles 1, part of the input light will be coupled into the sample fluid (this is called “frustrated total internal reflection”), and the reflected intensity will be reduced (while the reflected intensity will be 100% for a clean interface and no interaction). Depending on the amount of disturbance, i.e. the amount of target particles on or very near (within about 200 nm) to the TIR surface (not in the rest of the sample chamber 2), the reflected intensity will drop accordingly. This intensity drop is a direct measure for the amount of bound target particles 1, and therefore for the concentration of target particles in the sample. When the mentioned interaction distance of the evanescent wave of about 200 nm is compared with the typical dimensions of anti-bodies, target molecules and magnetic beads, it is clear that the influence of the background will be minimal. Larger wavelengths λ will increase the interaction distance, but the influence of the background liquid will still be very small. Another reason for the low background is that most biological materials have relatively low refractive indices near to the refractive index of water, i.e. n=1.3. The magnetic beads typically consist of a matrix material that has a significantly higher refractive index (n=1.6) causing the outcoupling of the signal. Furthermore, the magnetic beads contain potentially light scattering magnetic or magnetizable grains.

The described procedure is independent of applied magnetic fields. This allows real-time optical monitoring of preparation, measurement and washing steps. The monitored signals can also be used to control the measurement or the individual process steps.

For the materials of a typical application, medium A of the carrier 111 can be glass and/or some transparent plastic with a typical refractive index of 1.52. Medium B in the sample chamber 2 will be water-based and have a refractive index close to 1.3. This corresponds to a critical angle θ_{c} of 60°. An angle of incidence of 70° is therefore a practical choice to allow fluid media with a somewhat larger refractive index (assuming n_{A}=1.52, n_{B} is allowed up to a maximum of 1.43). Higher values of n_{B} would require a larger n_{A} and/or larger angles of incidence.

Advantages of the described optical read-out combined with magnetic labels for actuation are the following:
Cheap cartridge: The carrier 111 can consist of a relatively simple, injection-molded piece of polymer material.
Large multiplexing possibilities for multi-analyte testing: The contact surface 112 in a disposable cartridge can be optically scanned over a large area. Alternatively, large-area imaging is possible allowing a large detection array. Such an array (located on an optical transparent surface) can be made by e.g. ink jet printing of different binding molecules on the optical surface. The method also enables high-throughput testing in well-plates by using multiple beams and multiple detectors and multiple actuation magnets (either mechanically moved or electro-magnetically actuated).
Actuation and sensing are orthogonal: Magnetic actuation of the target particles (by large magnetic fields and magnetic field gradients) does not influence the sensing process. The optical method therefore allows a continuous monitoring of the signal during actuation. This provides a lot of insights into the assay process and it allows easy kinetic detection methods based on signal slopes.
The system is really surface sensitive due to the exponentially decreasing evanescent field.
Easy interface: No electric interconnect between cartridge and reader is necessary. An optical window is the only requirement to probe the cartridge. A contact-less read-out can therefore be performed.
Low-noise read-out is possible.

During the practical use of the described microelectronic sensor device 100 it turns out that magnetic actuation forces induced by each of the actuation coils 141, 142, 143 are often not accurately defined locally at the binding spot on the contact surface 112. Well-defined force application is however extremely important, since e.g. too strong attraction forces may introduce non-specific binding at the contact surface while too strong magnetic washing forces may remove specific binding as well. On the other hand, too small actuation forces can also affect the assay. Moreover, the alignment of the disposable cartridge/carrier 111 with respect to the microelectronic sensor device is important, e.g. to project the individual binding spots of target particles 1 on the optical detector 131 and to concentrate the magnetic forces to said binding spots. Obviously this is increasingly important in a multi-analyte biosensor and with a limited amount of photosensitive elements of the light detector 131 per binding spot.

To address the aforementioned issues, it is proposed in a first approach to use the mutual inductances (magnetic coupling) between the actuation coils 141, 142, 143 and/or their self-inductances as a position sensor. This approach is based on the observation that the super paramagnetic beads in the target particles 1 will affect the magnetic coupling between the actuation coils as well as their individual self-inductance, which can be used to obtain information about the position of said magnetic target particles 1 with respect to the actuation coils. As the relative position of the actuation coils 141, 142, 143 with respect to the optical light path is fixed, said information can be used to align the carrier 111 in the microelectronic sensor device 100. It should be noted that this principle is applicable to all kinds of sensors comprising external actuation coils, e.g. magnetic biosensors (cf. WO 2005/010542, WO 2005/010543).

In the setup of FIG. 1, a control unit 150 is provided that is coupled via inputs 151 to the actuation coils 141, 142, and 143 for controlling their activity (e.g. modulating with a modulator 154 the currents through the coils) and for sensing with a voltage sensor 152 their reactions (e.g. induced voltages in the coils). Thus the control unit 150 can detect the presence of a carrier 111 in the microelectronic sensor device by observing a mutual coupling change between the actuation coils 141, 142, and 143, as well as a self-induction change of said coils caused by the presence of super paramagnetic magnetic beads in their magnetic field. Obviously the magnetic coupling may be evaluated by an evaluation unit 153 in the time domain (by e.g. supplying with the modulator 154 pulse-currents to the actuation coils 141, 142, 143 and observing with the voltage sensor 152 the different responses, i.e. induced voltages in the coils) as well as in the frequency domain (by looking at varying frequency components).

Alternatively extra magnetic material, e.g. in the form of a marker 120 on top of the sample chamber 2, can be added to the cartridge 111 in order to
improve the effect of magnetic actuation by shaping (concentrating) magnetic flux;
improve the effect of the detection principle described above;
realize more detection area.

In another approach, not (only) the presence of the carrier 111 is detected by the control unit 150, but (also) the position of the magnetic target particles 1 in the sample chamber 2 is detected by combining the mutual couplings and self-inductances of the actuation coils 141, 142, 143. This information can then be used to position the carrier 111 towards a well-defined position with respect to the actuation coils. Such an approach is particularly possible if the magnetic target particles 1 are (still) concentrated in one sub-region, e.g. a storage at the top of the sample chamber 2.

Furthermore the position information can be used to indicate the area of interest when using e.g. a CCD detector 131, which is beneficial as there is no need for extra markers in the detection plane. The position information can also be used to give coarse-information upon the alignment marker position, which reduces the acquisition time to find said markers.

It should be noted that by adding extra coils, obviously more spatial resolution can be realized.

FIG. 1 further shows links between the control unit 150 and other components of the microelectronic sensor device 100, e.g. the light source 130 and the light detector 131. Via these links, the control unit 150 can steer the operation of the device, e.g. start measurements as soon as a carrier 111 is correctly placed.

FIG. 2 shows schematically a second approach to realize a microelectronic sensor device 200 according to the present invention. As above, the sensor device 200 comprises three actuation electromagnets 241, 242, 243 coupled to a control unit 250 for generating (e.g. modulated) magnetic fields inside a target region 210. Moreover, the sensor device 200 comprises a light source (not shown) for generating an input light beam L1 and a light detector (not shown) for detecting the output light beam L2 resulting after frustrated total internal reflection at a contact surface of an exchangeable carrier 211.

The mentioned cartridge or carrier 211 comprises a flat optical substrate 213 and a glass cover 215 which are separated by spacers 214 (e.g. double sided tape), thus creating a sample chamber 2. The carrier 211 further comprises magnetic field sensors in the form of coils 221, 222, 223 at fixed relative locations. These field sensor coils are electrically coupled to contact terminals 225 on the carrier 211 that can electrically be contacted in an interface by input terminals 251 of the control unit 250. For purposes of illustration, the Figure shows three possible arrangements of the magnetic field sensor coils, while in practice it would usually suffice to realize one of them. The shown possibilities are
a coil 221 on the bottom side of the optical substrate 213;
a coil 222 between the optical substrate 213 and the spacers 214;
a coil 223 on top of the cover 215,

wherein each coil encircles the target region 210 with one loop and

wherein the Figure shows two sections through the wire of each loop. It should be noted that direct electrical contact of the coils 221, 222, 223 with the sample fluid is not preferred, since this may short-circuit the configuration and/or cause electrolyses of the sample fluid.

FIG. 3 shows in a top view a first possible realization of a field sensor coil 321 as a single loop on a carrier 311.

FIG. 4 shows in a top view a second possible realization of a field sensor coil 421 as a spiral coil on a carrier 411 (which requires a return-line in a second layer).

Moreover, other magnetic sensors such as Hall or GMR sensors could as well be integrated in a cartridge instead of the coils described above.

Returning to FIG. 2, the mutual inductances (magnetic coupling) between the electromagnets 241, 242, 243 and the field sensor coils 221, 222, 223 on the carrier 211 can be used as a position sensor: As both the relative position of the actuation coils 241, 242, 243 with respect to the optical light path and the relative position of the field sensor coils 221, 222, 223 with respect to the carrier 211 are known, said information can be used to align the carrier in the microelectronic sensor device 200.

In addition, the presence of super paramagnetic beads 1 in the sample chamber 2 will affect the magnetic coupling between the actuation coils 241, 242, 243 and the field sensor coils 221, 222, 223 as well as their individual self-inductances, which can be used to obtain information about the position of said magnetic beads with respect to the field sensor coils.

As the microelectronic sensor device 200 contacts the field sensor coils 221, 222, 223 via electrical connections 251/225, the presence of the cartridge 211 can be detected by measuring the resistance and/or the inductance across these electrical connections: when a cartridge is present, the connection is of low impedance, otherwise it is of high impedance. Alternatively, the presence of the cartridge 211 can be detected by applying a signal to at least one actuation coil 241, 242, 243 and receiving the signal in the field sensor coil 221, 222, 223 resulting from the mutual coupling between the coils.

Furthermore, the position (not only the presence) of the cartridge 211 with respect to the microelectronic sensor device 200 can be determined by measuring the signal response of the field sensor coil(s) 221, 222, 223 when signals are applied to the top and bottom actuation coils 241, 242, 243. This information can be used to move the carrier 211 towards a well-defined position with respect to the actuation coils, or alternatively, to adjust the signals exciting the actuation coils. Furthermore the position information can be used to indicate the area of interest when using a CCD read-out, which is beneficial as there is no need for extra markers in the detection plane.

Various excitation strategies can be devised to obtain a cartridge position dependent signal from the field sensor coils 221, 222, 223. In a preferred embodiment, equal but opposite pulse currents are applied simultaneously to the top (243) and bottom (241, 242) actuation coils, such that the magnitude and direction of the combined response as measured with the field sensor coils reveals information on the position of the cartridge 211 with respect to the reader 200. This method provides accurate information, since the field sensor coil response equals zero for good centering between the top and bottom actuation coils, and the gradient of the response to the mis-positioning is rather large.

As sketched in FIG. 5, multiple binding sites can be present on the optical substrate of a carrier 511 in a multi-analyte assay. In this case each analyte binding site 512 can be equipped with a field sensor coil 521. By evaluating the response of the different coils 521, information can be obtained on the alignment of the reader and cartridge 511 in the plane parallel to the optical substrate. The alignment of the disposable cartridge with respect to the reader during a measurement is important, e.g. to project the individual binding spots 512 correctly on an optical detector. In addition, as the coils 521 mark the binding sites, information from each coil can be used to concentrate the magnetic forces to said binding spots.

Furthermore, by applying a current into an actuation coil and measuring the inductive response near the binding spots, the relation between force and applied actuation current can be measured and calibrated for each of the coils. Nulling of the resulting flux will can be used to balance the actuation currents.

For more information on modifications and applications of the microelectronic sensor device 200, reference is made to the corresponding description of FIG. 1.

While the invention was described above with reference to particular embodiments, various modifications and extensions are possible, for example:
The sensor can be any suitable sensor to detect the presence of particles on or near to a sensor surface, based on any property of the particles, e.g. it can detect via magnetic methods, optical methods (e.g. imaging, fluorescence, chemiluminescence, absorption, scattering, surface plasmon resonance, Raman, etc.), sonic detection (e.g. surface acoustic wave, bulk acoustic wave, cantilever, quartz crystal etc), electrical detection (e.g. conduction, impedance, amperometric, redox cycling), etc.
A magnetic sensor can be any suitable sensor based on the detection of the magnetic properties of the particle on or near to a sensor surface, e.g. a coil, magneto-resistive sensor, magneto-restrictive sensor, Hall sensor, planar Hall sensor, flux gate sensor, SQUID, magnetic resonance sensor, etc.
In addition to molecular assays, also larger moieties can be detected with sensor devices according to the invention, e.g. cells, viruses, or fractions of cells or viruses, tissue extract, etc.
The detection can occur with or without scanning of the sensor element with respect to the sensor surface.
Measurement data can be derived as an end-point measurement, as well as by recording signals kinetically or intermittently.
The particles serving as labels can be detected directly by the sensing method. As well, the particles can be further processed prior to detection. An example of further processing is that materials are added or that the (bio)chemical or physical properties of the label are modified to facilitate detection.
The device and method can be used with several biochemical assay types, e.g. binding/unbinding assay, sandwich assay, competition assay, displacement assay, enzymatic assay, etc. It is especially suitable for DNA detection because large scale multiplexing is easily possible and different oligos can be spotted via ink jet printing on the optical substrate.
The device and method are suited for sensor multiplexing (i.e. the parallel use of different sensors and sensor surfaces), label multiplexing (i.e. the parallel use of different types of labels) and chamber multiplexing (i.e. the parallel use of different reaction chambers).
The device and method can be used as rapid, robust, and easy to use point-of-care biosensors for small sample volumes. The reaction chamber can be a disposable item to be used with a compact reader, containing the one or more field generating means and one or more detection means. Also, the device, methods and systems of the present invention can be used in automated high-throughput testing. In this case, the reaction chamber is e.g. a well-plate or cuvette, fitting into an automated instrument.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microelectronic sensor device (100, 200) for manipulating a sample in an exchangeable carrier (111-511), comprising
a) a number of n≧1 magnetic field generators (141-143, 241-243) for generating a magnetic field in a target region (110, 210);
b) a control unit (150, 250) with an input (151, 251) for detection signals indicating a magnetic effect caused by the magnetic field generators (141-143, 241-243), wherein the control unit is adapted to evaluate these detection signals with respect to the presence and/or state of the carrier (111-511) in the target region (110, 210).

2. The microelectronic sensor device (100, 200) according to claim 1,
characterized in that the control unit (150, 250) is coupled to the magnetic field generators (141-143, 241-243) and that the detection signals are related to the mutual coupling and/or the self-inductance of the magnetic field generators.

3. The microelectronic sensor device (200) according to claim 1,
characterized in that the detection signals are provided by at least one magnetic field sensor (221-521, 222, 223) that is attached to the carrier (211-511).

4. The microelectronic sensor device (100, 200) according to claim 1,
characterized in that the control unit (150, 250) is adapted to control the magnetic field generators (141-143, 241-243) such that their magnetic fields cancel at a predetermined location in the target region (110, 210).

5. The microelectronic sensor device (100, 200) according to claim 1,
characterized in that the target region (110, 210) is located between two magnetic field generators (141-143, 241-243).

6. The microelectronic sensor device (100, 200) according to claim 1,
characterized in that the carrier (111-511) comprises a sample chamber (2) in which a sample can be provided, particularly a sample containing magnetic particles (1).

7. The microelectronic sensor device (100, 200) according to claim 1,
characterized in that the control unit (150, 250) is adapted to determine the position of a magnetically interactive substance (1, 120) in or at the carrier (111-511).

8. The microelectronic sensor device (100, 200) according to claim 1,
characterized in that the control unit (150, 250) comprises a modulator (154) for modulating the magnetic field of at least one of the magnetic field generators (141-143, 241-243).

9. The microelectronic sensor device (100, 200) according to claim 1,
characterized in that the control unit (150, 250) comprises a voltage sensor (152) for sensing the voltages between two terminals, particularly two terminals of at least one of the magnetic field generators (141-143, 241-243).

10. The microelectronic sensor device (100, 200) according to claim 9,
characterized in that the control unit (150, 250) comprises an evaluation module (153) for evaluating the measured voltages, particularly in the time domain or in the frequency domain.

11. The microelectronic sensor device (100, 200) according to claim 1,
characterized in that the control unit (150, 250) is adapted to control components (130, 131) of the microelectronic sensor device in dependence on its evaluation results.

12. The microelectronic sensor device (100, 200) according to claim 1,
characterized in that it comprises a light source (130) for emitting an input light beam (L1) into the carrier (111-511) such that it is totally internally reflected at a contact surface (112) of the carrier (111-511) as an output light beam (L2).

13. The microelectronic sensor device (100, 200) according to claim 12,
characterized in that it comprises a light detector (131) for determining a characteristic parameter of the output light beam (L2).

14. A carrier (111-511) for a microelectronic sensor device (100, 200) according to claim 1,
comprising a magnetically interactive marker (120) and/or a magnetic field sensor (221-521, 222, 223) at a fixed relative location.

15. The carrier (211-511) according to claim 14,
characterized in that the magnetic field sensor comprises a coil (221-521, 222, 223), a Hall sensor, a planar Hall sensor, a flux gate sensor, a SQUID, a magnetic resonance sensor, a magneto-restrictive sensor, or magneto-resistive sensor like a GMR, a TMR, or an AMR element.

16. The carrier (211-511) according to claim 14,
characterized in that it comprises electrical contact terminals (225) via which the magnetic field sensor (221-521, 222, 223) can be accessed.

17. A method for manipulating a sample in an exchangeable carrier (111-511), comprising
a) generating a magnetic field in a target region (110, 210) with a number of n 1 magnetic field generators (141-143, 241-243);
b) evaluating a magnetic effect caused by the magnetic field generators (141-143, 241-243) with respect to the presence and/or state of the carrier (111-511) in the target region (110, 210).

18. Use of the microelectronic sensor device (100, 200) or the carrier (111-511) according to claim 1 for molecular diagnostics, biological sample analysis, or chemical sample analysis.
